(19) United States
(12) Patent Application Publication
(10) Pub. No.: US 2008/0231517 A1
(43) Pub. Date: Sep. 25, 2008

(54) Multi-band antenna

(75) Inventor: Ming Zheng, Farnborough (GB)

Correspondence Address: HARRINGTON & SMITH, PC, 4 RESEARCH DRIVE, SHELTON, CT, 06484-6212, US

(73) Assignee: Nokia Corporation

(21) Appl. No.: 11/999,225

(22) Filed: Dec. 3, 2007

Related U.S. Application Data
(63) Continuation of application No. 10/896,212, filed on Jul. 20, 2004, now Pat. No. 7,307,591.

(51) Int. Cl. H01Q 1/38

(52) U.S. Cl. 343/700 MS

(57) ABSTRACT

An antenna having a plurality of resonant frequencies and comprising a feed point, a ground point and a conductive track that extends from the feed point and returns to the ground point and means for locally increasing the reactance of the antenna track at a first position coincident with a maximum electromagnetic field associated with at least one of the plurality of resonant frequencies.

### PRIORITY STATEMENT

This application is a continuation of U.S. patent application Ser. No. 10/896,212, filed on Jul. 20, 2004, and claims benefit thereof under 35 U.S.C. § 120.

### FIELD OF THE INVENTION

Embodiments of the invention relate to multi-band antennas. One embodiment relates to a planar antenna that is suitable for use as an internal antenna in a cellular radio communication terminal.

### BACKGROUND TO THE INVENTION

A current internal antenna used as an internal antenna in cellular mobile telephones is the Planar Inverted-F antenna (PIFA). This type of antenna comprises an antenna element 12 that is parallel to a ground plane that connects the ground point and feed point together towards one end of the antenna element. These antennas suffer from a number of disadvantages. They have at most two operational resonant frequencies which could be used at the cellular bands. The separation between the antenna element and the ground plate needs to be kept fairly large (˜7 mm) in order to maintain a satisfactory bandwidth.

It would be desirable to provide a more compact antenna particularly one with a low profile.

It would be desirable to provide an antenna with three operational resonant frequencies, which could be used at the cellular bands

### BRIEF DESCRIPTION OF THE INVENTION

According to one aspect of the invention there is provided an antenna having a plurality of resonant frequencies and comprising a feed point, a ground point and a conductive track that extends from the feed point and returns to the ground point and means for locally increasing the reactance of the antenna track at a first position coincident with a maximum electromagnetic field associated with at least one of the plurality of resonant frequencies.

According to another aspect of the invention there is provided an antenna having a plurality of resonant frequencies and comprising a feed point, a ground point and a conductive track that extends from the feed point and returns to the ground point and further comprising means for locally raising the capacitance of the antenna track at a first position coincident with a maximum electric field (E field) associated with at least one of the plurality of resonant frequencies.

According to another aspect of the invention there is provided an antenna having a plurality of resonant frequencies and comprising a feed point, a ground point and a conductive track that extends from the feed point and returns to the ground point and further comprising means for locally raising the inductances of the antenna track at positions coincident with maximum magnetic field (H fields) associated with at least one of the plurality of resonant frequencies.

According to another aspect of the invention there is provided an antenna having a plurality of resonant frequencies and comprising a feed point, a ground point and a conductive track that extends from the feed point and returns to the ground point and further comprising means for locally raising the inductance of the antenna track at positions ¼ and ¾ way along the conductive track.

According to another aspect of the invention there is provided an antenna having a plurality of resonant frequencies and comprising a feed point, a ground point and a conductive track that extends from the feed point and returns to the ground point and further comprising means for locally raising the capacitance of the antenna track at a position half way along the conductive track.

Embodiments of the invention advantageously use a loop-like antenna as a folded monopole, folded dipole antenna.

### BRIEF DESCRIPTION OF THE DRAWINGS

For a better understanding of the present invention reference will now be made by way of example only to the accompanying drawings in which:

FIGS. 1A and 1B illustrate a planar multi-band antenna;

FIG. 2A, 2B, 2C illustrates simplified vector current distribution for the resonant modes (0,0), (1,0) and (0,1);

FIG. 3 illustrates the typical return loss of the resonant modes (0,0), (1,0) and (0,1) for a loaded, planar, folded monopole, folded dipole antenna;

FIG. 4 illustrates another example of a loaded, planar, folded monopole, folded dipole antenna;

FIG. 5 illustrates another example of a loaded, planar, folded monopole, folded dipole antenna; and

FIG. 6 illustrates a radio transceiver device comprising a loaded, folded monopole, folded dipole antenna.

### DETAILED DESCRIPTION OF THE INVENTION

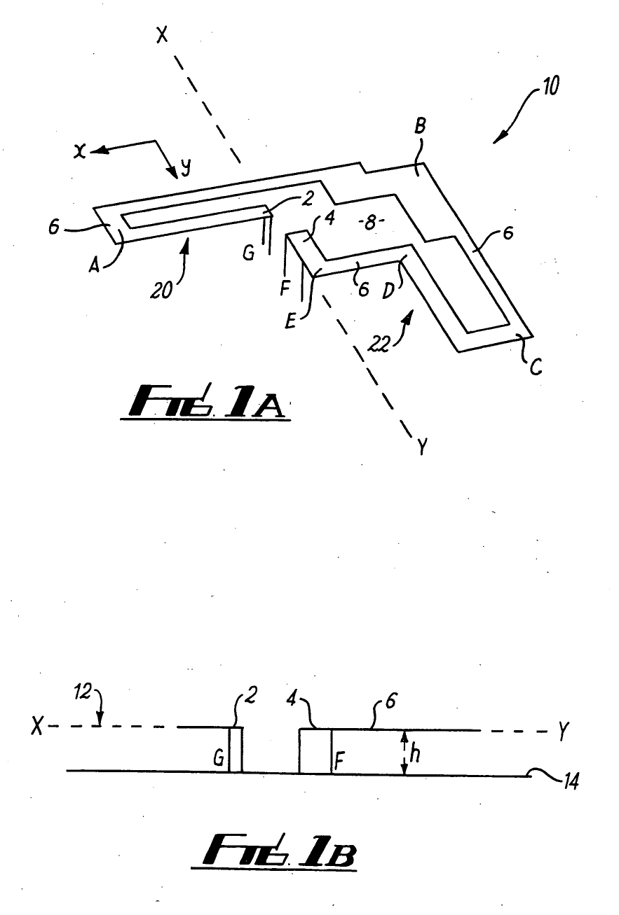

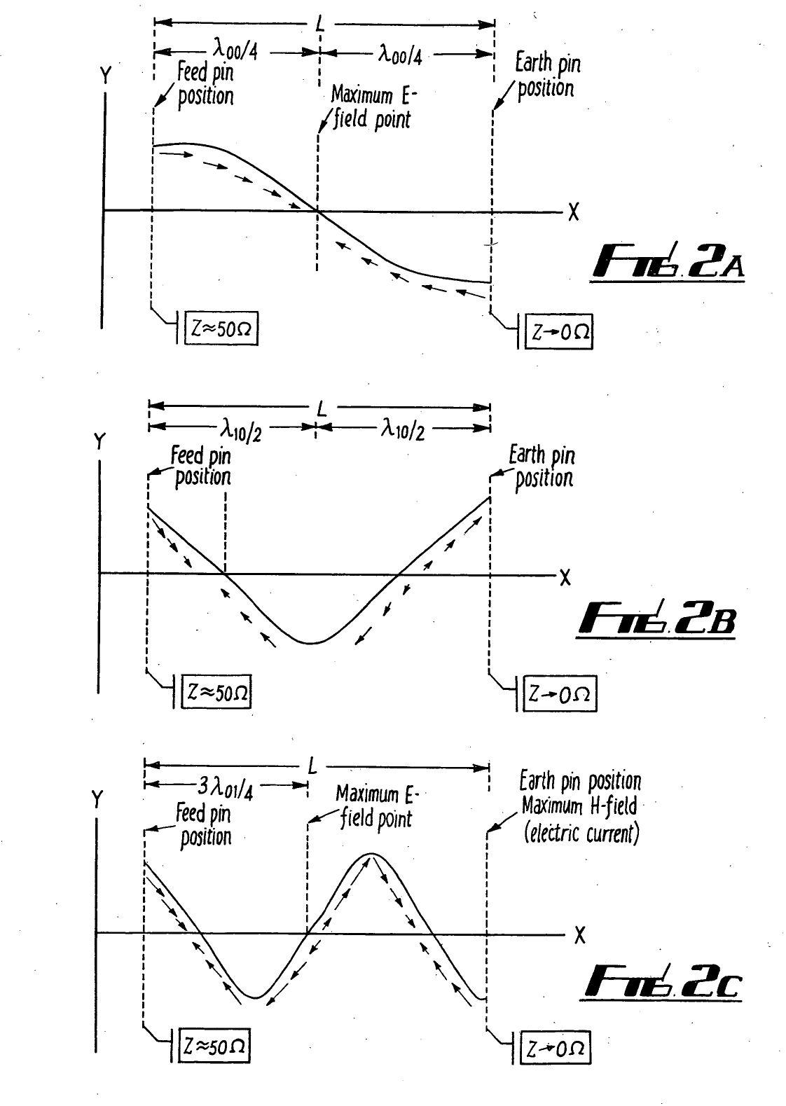

The FIGS. 1A, 1B, 4 and 5 illustrate antennas having a plurality of resonant frequencies and comprising a feed point, a ground point and a conductive track that extends from the feed point and returns to the ground point and means for locally increasing the reactance of the antenna track at a first position coincident with a maximum electromagnetic field associated with at least one of the plurality of resonant frequencies. The capacitance may be locally increased where the E field is maximum and/or the inductance may be locally increased where the H field is maximum.

FIGS. 1A and 1B illustrate a planar multi-band antenna 10. The antenna is a planar folded monopole, folded dipole antenna and has a plurality of operational resonant frequencies. The particular antenna illustrated has three resonances that respectively cover the two EGSM bands (850,900 MHz), the PCN band (1800 MHz) and the PCS band (1900 MHz). The antenna 10 is particularly suited for use as an internal antenna of a mobile cellular radio terminal, such as a mobile telephone, as it has a low profile structure.

The antenna 10 is loop-like having a single ground point 2 adjacent a single feed point 4 and a single antenna track 6 that extends from the ground point 2 to the feed point 4 in a single loop-like structure.

The structure is non-circular and encloses a non-regular area of space 8. The track has a number of substantially acute angled bends (≦90 degrees) and lies in a flat geometric plane 12, which is parallel to the ground plane 14. The separation h between the track 6 and ground plane 14 can be made of the order of a few millimetres, which results in an advantageously low profile antenna 10.

A co-ordinate system 30 is included in FIG. 1A. This system 30 comprises an x vector that is orthogonal to a y vector. The feed point 4 is displaced from the ground point in a +y direction.

The single track 6 extends away from the ground point in an +x direction, makes two right angled right bends in quick succession at point A and returns in a −x direction past the feed point to point B. This return of track forms a first arm 20.

The track extends away from point B in an +y direction past the ground point 2 and feed point 4 but parallel to an imaginary line X-Y drawn between them, and makes two right angled right bends in quick succession at point C and returns in a −y direction to the feed point 4. This return of track forms a second arm 22. In this example, the second arm 22 is staggered as the track 6, before it reaches the feed point 4, makes a right angled left bend at point D, extends in the +x direction and then makes a right angled right bend at point E and extends in the −y direction to the feed point 4. The bends in the track 6 lie in the single geometric plane 12.

The first arm 20 and second arm 22 therefore extend orthogonally to each other but occupy the same geometric plane. However, the antenna is asymmetric as the first and second arms have a different shape because of the turns at points D and E.

The antenna track 10 has a substantially constant width except in the vicinity of the point B where the first and second arms join. The antenna track 10 is capacitively loaded in the vicinity of point B. This is achieved by increasing the width of the antenna track significantly in this area. This loading increases the capacitive coupling between the track 10 at this point and the ground plane 14.

It may be possible to use other forms of capacitive loading such as bringing the track in the vicinity of point B closer to the ground plane or providing a dielectric with increased electrical permittivity between the track 6 in the vicinity of point B and the ground plane 14. However, one of the most convenient ways to capacitively load the track 6 is by increasing its area by increasing the track width.

A folded dipole may be defined as two parallel λ/2 dipoles connected at their four open ends. If the length of the track 6 from ground point 2 to feed point 4 is L, then the resonant modes of a folded dipole may be represented by: L=n_{d}*λ, where n_{d} is a whole number representing a resonant folded dipole mode and λ is a electromagnetic wavelength of the resonant frequency for that mode. When n_{d}=0, the resonant mode dipole mode doesn't exist.

A folded monopole may be defined as two parallel λ/4 monopoles connected at their two open ends. The resonant modes of a folded monopole may be represented by: L=(2nₘ+1)*λ/2, where nₘ is a whole number representing a resonant folded monopole mode and λ is a electromagnetic wavelength of the resonant frequency for that mode.

The position (y_{d}) from the ground point of maximum electric field (Emax) for a folded dipole may be given by: y_{d}=(2*a_{d}−1)/n_{d}*(L/4) where a_{d}=1, . . . , 2n_{d}. However, in practice, the position of maximum E field may deviate slightly from the formula because of applied reactive loading.

The position (yₘ) from the ground point of maximum electric field (Emax) for a folded monopole may be given by: yₘ=(2*aₘ−1)/(2nₘ+1)*L/2 where aₘ=1, . . . , 2nₘ+1. However, in practice, the position maximum E field may deviate slightly from the formula because of applied reactive loading.

The table below sets out the lower 5 modes of the folded monopole, folded dipole antenna and the maximum E field positions. Each mode may be conveniently referred to as (n_{d}, nₘ). The wavelength corresponding to the resonant frequency of a mode (n_{d}, nₘ) may be conveniently referred to using λ_{nd nm}.

It should be noted, that for modes where n_{d}>0 and nₘ=0, the position of Max E field is given by y_{d} and not yₘ. It should be noted, that for modes where n_{d}=0, the position of Max E field is given by yₘ and not y_{d}.

| | | | | Max E field |
|---|---|---|---|---|
| n_{d} | nₘ | λ_{nd nm} | Frequency | position |
| 0 | 0 | 2L | 1/2 * 1/L* c | L/2 |
| 1 | 0 | L | 1/L* c | L/4, 3L/4 |
| 0 | 1 | 2L/3 | 3/2* 1/L* c | L/6 L/2 |
| | | | | 5L/6 |
| 2 | 0 | L/2 | 2 *1/L* c | L/8, 3L/8, |
| | | | | 5L/8, 7L/8 |
| 0 | 2 | 2L/5 | 5/2*1*/L* c | L/10, 3L/10, |
| | | | | L/2, 7L/10, |
| | | | | 9L/10 |
| . | . | . | . | . |

c: velocity of electromagnetic wave

In the (0,0) mode the antenna operates as two λ/4 monopole structures connected at the max E field position L/2. λ₀₀ corresponds to 2 L.

In the (1, 0) mode the antenna operates as two λ/2 dipole structures which are connected in parallel at positions coincident with the maximum E field positions L/4 and 3 L/4. λ₁₀ corresponds to L.

In the (0,1) mode the antenna operates in a resonant mode of two λ¾ monopole structures connected at max E field position L/2. λ₀₁ corresponds to 2 L/3.

Capacitive loading at the position from the ground point of maximum electric field (Emax) for a mode, reduces the resonant frequency of that mode.

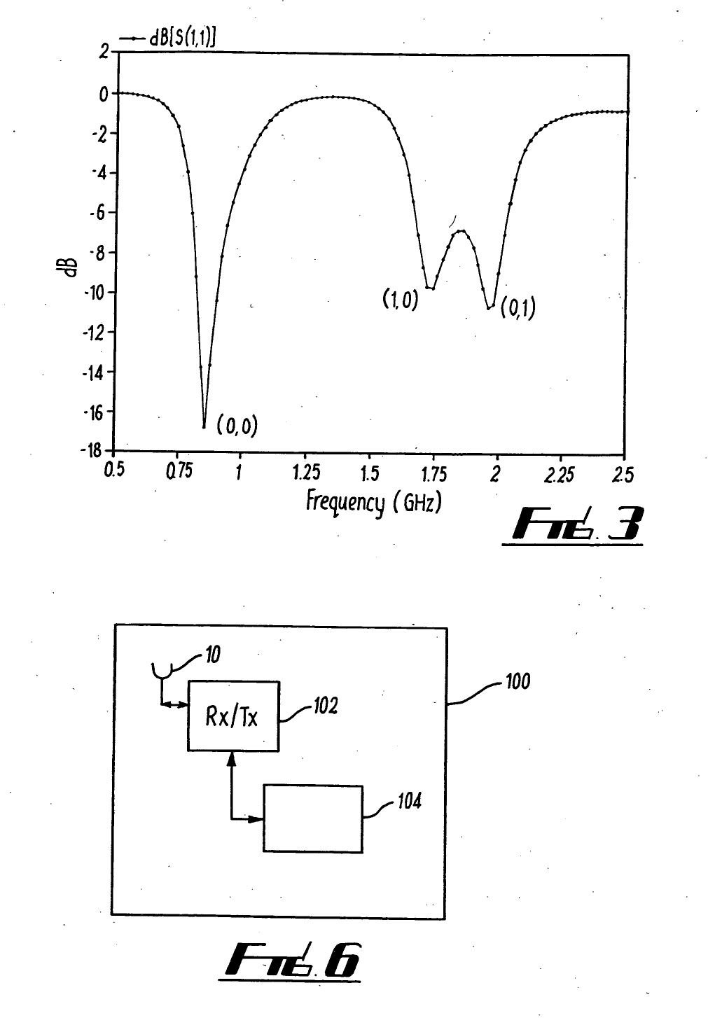

The capacitive loading at L/2 of the antenna 10 of FIGS. 1A and 1B reduces the resonant frequency of the folded monopole modes (0,0), (0,1). The resonant modes (0,0), (1,0) and (0,1) for the loaded, planar, folded monopole, folded dipole antenna is illustrated in FIG. 3.

Due to the asymmetry of the first and second arms the (0,0) mode has two slightly different resonant frequencies that overlap to form a resonant frequency with a bandwidth that is larger than a single monopole. This large bandwidth is suitable for EGSM (850,900 MHz). FIG. 2A illustrates a simplified vector current distribution for this mode.

Due to the asymmetry of the first and second arms the (0,1) mode has two slightly different resonant structures, their frequencies overlap to form an antenna with a bandwidth that is larger than a single λ/2 resonant element. This larger bandwidth is suitable for PCN (1800 MHz). FIG. 2B illustrates a simplified vector current distribution for this mode.

The (0,1) mode is suitable for PCS (1900 MHz). FIG. 2C illustrates a simplified vector current distribution for this mode.

The antenna 10 must of course satisfy some electromagnetic boundary conditions. The electrical impedance at the feed point is close to 50 Ohm and the electrical impedance at the ground point is close to 0 Ohm.

It should be noted that the electromagnetic coupling between the arms ABC and ADC is optimised to obtain an acceptable return loss (e.g. 6 dB) at the cellular bands. The coupling is controlled by varying the distance between the above two arms.

The antenna 10 has advantageously large bandwidths. This enables the distance between the antenna track and ground plane to be reduced, as the bandwidth is sufficiently big to withstand the consequent increase in Q and narrowing of the bandwidth. This makes it very suitable as an internal antenna for hand-portable devices. In addition, the antenna 10 is not sensitive to a ground plane by comparison to a normal PIFA.

FIG. 4 illustrates another example of a loaded, planar, folded monopole, folded dipole antenna 10. The antenna has a plurality of operational resonant frequencies. The particular antenna illustrated has three resonances that respectively cover the two EGSM bands (850,900 MHz), the PCN band (1800 MHz) and the PCS band (1900 MHz). The antenna 10 is particularly suited for use as an internal antenna of a mobile cellular radio terminal, such as a mobile telephone, as it has a low profile.

The antenna 10 is loop-like having a single ground point 2 adjacent a single feed point 4 and a single antenna track 6 that extends from the ground point 2 to the feed point 4 in a single loop-like structure.

The structure encloses a non-regular area of space 8. The 6 track has a number of substantially acute angled bends (≦90 degrees) and lies in a flat geometric plane 12, which is parallel to the ground plane 14. The separation h between the track 6 and ground plane 14 can be made of the order of a few millimetres, which results in an advantageously low profile antenna 10.

A co-ordinate system 30 is included in FIG. 4. This system 30 comprises an x vector that is orthogonal to a y vector. Directions concerning FIG. 4 will be expressed as a vector [x,y]. The feed point 4 is displaced from the ground point in a +y direction.

The single track 6 extends away from the ground point in a [1,1] direction, makes an acute angled left bend at point A, extends in direction [−1,0] to point B, then makes an acute angled left bend at point B. The track extends in direction [0, −1] to point C where in makes a right angled left bend and extends in direction {1,0] to pint D. At point D, the track makes a right angled left bend and extends in direction [0, 1] to point E, where it makes an acute angled left bend and extends in direction [−1,−1] to the feed point 4.

The antenna track 10 is capacitively loaded in the vicinity of point C at L/2. This is achieved by having the ground point 2 proximal to point C. This loading increases the capacitive coupling between the track 10 at this point and ground.

The structure is asymmetric as the length of track between points A and C is less than the length of track between points E and C.

In the preceding examples, capacitive loading is applied at a point of maximum E field for a mode in order to reduce the resonant frequency of that mode.

It is also alternatively or additionally possible to apply inductive loading at a point (e.g., 32 or 34 in FIG. 2C) of maximum H field for a mode in order to reduce the resonant frequency of that mode. One way of providing inductive loading is to narrow the width of the track

For a folded monopole, the position of maximum H field may be L*bₘ/(2nₘ+1), where bₘ=0, . . . , 2nₘ+1. For a folded dipole, the position of maximum H field may be L*b_{d}/2n_{d} where b_{d}=0, . . . , 2n_{d}. When n_{d}=0, the dipole mode doesn't exist, therefore the above formula is not applied for n_{d}=0. However, in practice, the position of maximum H field may deviate slightly from the formulae because of applied reactive loading.

The table below sets out the lower 5 modes of the folded monopole, folded dipole antenna and the maximum H field positions. Each mode may be conveniently referred to as (n_{d}, nₘ). The wavelength corresponding to the resonant frequency of a mode (n_{d}, nₘ) may be conveniently referred to using λ_{nd nm}.

| | | | | Max H field |
|---|---|---|---|---|
| n_{d} | nₘ | λ_{nd nm} | Frequency | position |
| | 0 | 2L | 1/2 * 1/L* c | 0, L |
| 1 | | L | 1/L* c | 0, L/2, L |
| | 1 | 2L/3 | 3/2 *1/L* c | 0, L/3 (ref |
| | | | | #32) , 2L/3 |
| | | | | (ref #34), L |
| 2 | | L/2 | 2 * 1/L* c | 0, L/4, L/2, |
| | | | | 3L/4, L |
| 0 | 2 | 2L/5 | 5/2*1/1* c | 0, L/5, 2L/5, |
| | | | | 3L/5, 4L/5,L |
| . | . | . | . | . |

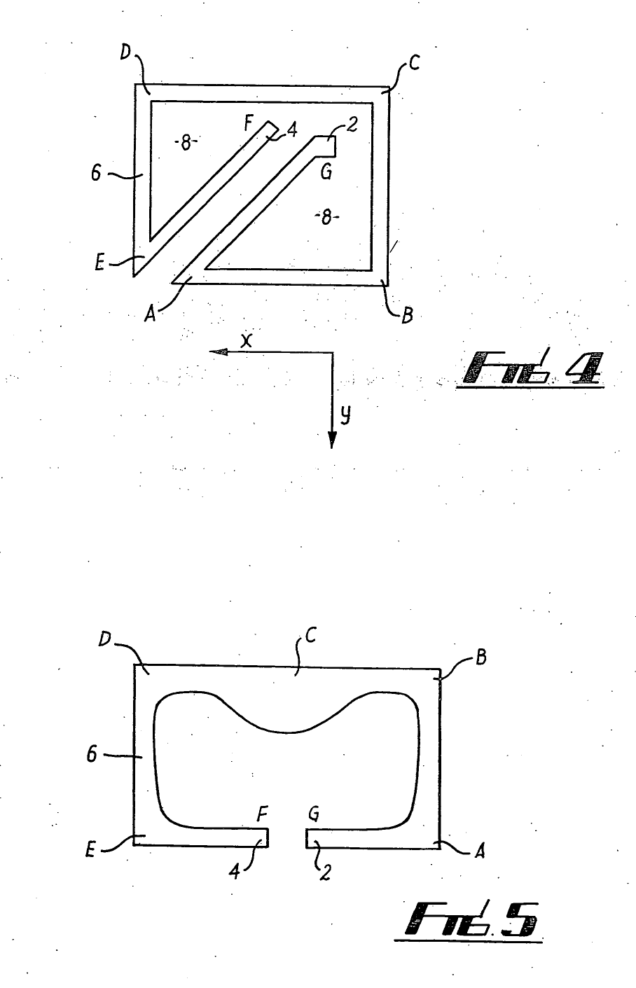

FIG. 5 illustrates another example of a loaded, planar, folded monopole, folded dipole antenna 10. In this antenna, the antenna track 6 makes obtuse rather than acute angle bends. The antenna has capacitive loading at point C arising from the increase of antenna track width at this point.

FIG. 6 illustrates a radio transceiver device 100 such as a mobile cellular telephone, cellular base station, other wireless communication device or module for such a device. The radio transceiver device 100 comprises a planar multi-band antenna 10, as described above, radio transceiver circuitry 102 connected to the feed point of the antenna and functional circuitry 104 connected to the radio transceiver circuitry. In the example of a mobile cellular telephone, the functional circuitry 104 includes a processor, a memory and input/out put devices such as a microphone, a loudspeaker and a display. Typically the electronic components that provide the radio transceiver circuitry 102 and functional circuitry 104 are interconnected via a printed wiring board (PWB). The PWB may be used as the ground plane 14 of the antenna 10 as illustrated in FIG. 1B.

Although embodiments of the present invention have been described in the preceding paragraphs with reference to various examples, it should be appreciated that modifications to the examples given can be made without departing from the spirit and scope of the invention. Although, in the examples illustrated the conductive track lies in a plane parallel to a ground plane, this is not essential to the proper functioning of the antenna and the conductive track may lie in a plane that is not parallel to a ground plane.

1-31. (canceled)

32. An antenna comprising:
a feed point;
a ground point; and
antenna track means that extends from the feed point and returns to the ground point to form one of a folded monopole or a folded dipole and arranged for locally and permanently increasing the reactance of the antenna track means at a first position, between the feed point and the ground point, coincident with a maximum electromagnetic field associated with at least one of a plurality of resonant frequencies,
wherein the antenna track means comprises an acute angled bend at the first position.

33. The antenna of claim 32, wherein the antenna track means is arranged for localized capacitive loading at the first position, and for localized inductive loading at a third position which is coincident with a maximum H-field associated with at least one of the plurality of resonant frequencies

34. The antenna of claim 32, wherein the localized capacitive loading comprises a locally increased track means area compared to adjacent portions of the antenna track means.

35. The antenna of claim 32, wherein the localized capacitive loading arises from the location of the ground point adjacent to but separated from the first position.

36. The antenna of claim 32, wherein the antenna track means is arranged for localized capacitive loading at the first position, and wherein the first position is (2*a_{d}−1)/4*n_{d} along the length of the antenna track means, where a_{d} is equal to one of 1, . . . , 2n_{d} and n_{d} is a natural number.

37. The antenna of claim 32, wherein the antenna track means is arranged for localized capacitive loading at the first position, and wherein the first position is (2*aₘ−1)/((2nₘ+1)*2) along the length of the antenna track means, where aₘ is equal to one of 1, . . . , 2nₘ+1 and nₘ is a whole number.

38. The antenna of claim 32, wherein the first position is half way along the length of the antenna track means.

39. The antenna of claim 32, wherein the antenna track means lies in a single plane parallel to a ground plane.

40. The antenna of claim 32, wherein the antenna track means lies in a single plane not parallel to a ground plane.

41. The antenna of claim 32, wherein the antenna track means is arranged for locally raising the capacitance of the conductive antenna track at the first position, wherein the first position is (2*aₘ−1)/(2nₘ+1) along the length of the antenna track means where aₘ=1, . . . , 2nₘ+1 and nₘ is a whole number.

42. The antenna of claim 32, disposed within a portable radio device and coupled to a transceiver.

43. An antenna comprising:
a feed point;
a ground point; and
antenna track means that extends from the feed point and returns to the ground point to form one of a folded monopole or a folded dipole and arranged for localized inductive loading of the antenna track means at a first position, between the feed point and the ground point which is coincident with a maximum H-field associated with the at least one of a plurality of resonant frequencies, and wherein the first position is b_{d}/2n_{d} along the length of the antenna track means where b_{d} is equal to one of 0, . . . , 2n_{d} and n_{d} is a whole number.

44. The antenna of claim 43, wherein the first position is one of ⅓ and ⅔ along the antenna track means and the antenna track means is further arranged for localized inductive loading of the antenna track means at the other of ⅓ and ⅔ along the antenna track means.

45. An antenna comprising:
a feed point;
a ground point; and
antenna track means that extends from the feed point and returns to the ground point to form one of a folded monopole or a folded dipole and arranged for localized inductive loading of the antenna track means at a first position, between the feed point and the ground point which is coincident with a maximum H-field associated with the at least one of a plurality of resonant frequencies, and wherein the first position is bₘ/(2nₘ+1) along the length of the antenna track means where bₘ is equal to one of 0, . . . , 2nₘ+1 and nₘ is a whole number.

46. The antenna of claim 45, wherein the antenna track means is arranged for localized inductive loading at a second position, wherein the second position is coincident with a maximum H-field associated with at least one of the plurality of resonant frequencies.

47. The antenna of claim 43, wherein the first position is one of ⅓ and ⅔ along the antenna track means and the second position is the other of ⅓ and ⅔ along the antenna track means.

48. The antenna of claim 46 wherein the configuration is permanent.

49. A method comprising:
providing an antenna having a conductive antenna track that extends from a feed point and returns to a ground point to form one of a folded monopole or a folded dipole and arranged for locally and permanently increasing the reactance of the conductive antenna track at a first position, between the feed point and the ground point, that is coincident with a maximum electromagnetic field associated with at least one of a plurality of resonant frequencies for which the antenna is operative, wherein the conductive antenna track comprises an acute angled bend at the first position; and
resonating the conductive antenna track at the at least one of the plurality of resonant frequencies for one of transmitting or receiving a wireless signal.

50. The method of claim 49, wherein the plurality of resonant frequencies comprise at least three of 850 MHz, 900 MHz, 1800 MHz, and 1900 MHz.

51. The method of claim 49, wherein the first position is approximately halfway between the feed point and the ground point.

52. The method of claim 49, wherein the conductive antenna track comprises an internal antenna of a portable communications device that comprises a transceiver.

53. A method comprising:
providing an antenna having a conductive antenna track that extends from a feed point and returns to a ground point to form one of a folded monopole or a folded dipole and arranged for locally and permanently increasing the reactance of the conductive antenna track at a first position, between the feed point and the ground point, that is coincident with a maximum H-field associated with at least one of a plurality of resonant frequencies for which the antenna is operative, and wherein the first position is either b/2n or b/(2n+1) along the length of the conductive antenna track where b is equal to one of 0, . . . , 2n and n is a whole number; and
resonating the conductive antenna track at the at least one of the plurality of resonant frequencies for one of transmitting or receiving a wireless signal.

54. The method of claim 53, wherein the plurality of resonant frequencies comprise at least three of 850 MHz, 900 MHz, 1800 MHz, and 1900 MHz.

55. The method of claim 53, wherein the conductive antenna track is arranged to locally raise the inductance of the antenna track means at positions ⅓ and ⅔ way along the conductive antenna track.

56. The method of claim 53, wherein the conductive antenna track comprises an internal antenna of a portable communications device that comprises a transceiver.
